(19) United States
(12) Patent Application Publication
(10) Pub. No.: US 2021/0120834 A1
(43) Pub. Date: Apr. 29, 2021

(54) Composition of Vegan Cheese and Method of Preparing the Same

(71) Applicant: Meng Fu Hsieh, Yun Lin County (TW)

(72) Inventors: Meng Fu Hsieh, Yun Lin County (TW); Meng Huang Hsieh, Yun Lin County (TW)

(21) Appl. No.: 16/664,125

(22) Filed: Oct. 25, 2019

(51) Int. Cl. A23C 20/02

(52) U.S. Cl. CPC A23C 20/025

(57) ABSTRACT

This specification discloses a composition of vegan cheese and method of preparing the same. The mentioned composition of vegan cheese and method of preparing the same can provide vegan cheese having the characteristics of real cheese by the design of the food structure and the condition control in the preparation process of the vegan cheese. Moreover, according to this specification, the mentioned composition of vegan cheese and method of preparing the same can provide vegan cheese product more in line with health requirements by not adding any emulsifier.

### BACKGROUND OF THE INVENTION

### 1. Field of the Invention

The present invention is generally related to a composition of vegan cheese and method of preparing the same, and more particularly to a composition of vegan cheese and method of preparing the same without emulsifier.

### 2. Description of the Prior Art

Cheese is one of the earliest fermented dairy products used by humans. Cheese is rich in protein, calcium, vitamins, trace elements, and so on. In order to meet the needs of food processing, people use the ingredients such as edible oils, proteins, starches, edible gums, emulsifiers, spices and pigments to prepare cheese analogues. Since the characteristics of the cheese analogues can be adjusted by changing the type and composition ratio of the raw materials, it is widely used as a processing ingredient for baked foods and Western fast foods, such as pizza. According to the difference in proportion of milk-related ingredients of various types of cheese analogues, it can be further divided into dairy, partial dairy, synthetic cheese analogues, wherein the synthetic cheese analogue is pure vegan cheese.

As people become more aware of health awareness and environmental awareness, reducing meat intake and choosing vegetarian food is a new trend. Therefore, there are more and more researches emerged on how to make vegan cheese closer to real cheese, and how to make vegan cheese used in food processing, such as pizza. Taking the Mozzarella cheese commonly used in pizza as an example, the original production principle is to adjust the milk acidity and rennet to make the casein curd, to stir the salty hot water at high temperature. And repeatedly do the stretching action, and gradually form a resilient cheese. However, the vegan cheese products of the presently commercially available mozzarella cheeses often have problems of uneven quality.

On the other hand, the emulsifier used in the preparation of the existing vegan cheese is a health controversial additive. A mouse study in the journal “Nature” in 2015 showed that either Carboxymethyl Cellulose (CMC) or Polysorbate 80 (P80) was incorporated into mouse drinking water or in solid food, mice develop mild inflammatory bowel disease and metabolic syndrome. Moreover, the most commonly used ingredients of emulsifiers are fatty acid monoglycerides, sucrose esters, etc. The former is a fatty type, and the trans fatty acids are high, long-term or large-scale use, which may cause disease outbreaks in patients with cardiovascular diseases and hypertension, so doctors recommend products containing emulsifiers should be eaten as little as possible.

In view of the above matters, developing a novel composition of vegan cheese and method of preparing the same having the advantage of stable in quality and close to real cheese and being able to reduce health concerns is still an important task for the industry.

### SUMMARY OF THE INVENTION

In light of the above background, in order to fulfill the requirements of the industry, the present invention provides a novel composition of vegan cheese and method of preparing the same having the advantage of providing vegan cheese product more in line with health requirements by not adding any emulsifier.

One objective of the present invention is to provide a composition of vegan cheese and method of preparing the same to provide vegan cheese close to real cheese without using any emulsifier through the condition control in the preparation process of the vegan cheese.

Another objective of the present invention is to provide a composition of vegan cheese and method of preparing the same to provide cheese analogues with excellent stability through the condition control in the preparation process of the vegan cheese.

Accordingly, the present invention discloses a composition of vegan cheese and method of preparing the same. The mentioned composition of vegan cheese and method of preparing the same, by the design of the food structure, can develop a functional vegetal material which can replace milk and rennet. The mentioned composition of vegan cheese and method of preparing the same also can develop a vegan cheese having the characteristics of mozzarella cheese (such as melting and stringing). According to this present specification, the mentioned composition of vegan cheese and method of preparing the same can improve the nutritional value and flavor of the vegan cheese by reducing the used additives and introducing functional materials. Therefore, according to the disclosure in the present specification, a vegan cheese having both nutritional value and flavor can be provided.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows a flowchart of a method of preparing vegan cheese of this invention; and

FIG. 2 shows the grape of an example of the emulsification stability of the vegan cheese at different storage temperature and different storage time of this invention.

### DESCRIPTION OF THE PREFERRED EMBODIMENTS

What probed into the invention is a composition of vegan cheese and method of preparing the same. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment according to this specification discloses a composition of vegan cheese. The mentioned composition of vegan cheese does not use any emulsifier. According to this embodiment, the composition of vegan cheese comprises water, starch, and vegetable oils and fats. In one preferred example of this embodiment, the composition of vegan cheese may further comprise vegetable protein. In another preferred example of this embodiment, the composition of vegan cheese may further comprise thickener. In another preferred example of this embodiment, the composition of vegan cheese may further comprise flavoring agent. In another preferred example of this embodiment, the composition of vegan cheese may further comprise emulsifying salt. In another preferred example of this embodiment, the composition of vegan cheese may further comprise acidulant. In another preferred example of this embodiment, the composition of vegan cheese may further comprise functional additive.

In one preferred example of this embodiment, the composition of vegan cheese comprises water in an amount of about 40-55 wt. % of the total weight of the vegan cheese. In one preferred example of this embodiment, the composition of vegan cheese comprises vegetable oils and fats in an amount of about 20-25 wt. % of the total weight of the vegan cheese. In one preferred example of this embodiment, the composition of vegan cheese comprises starch in an amount of about 10-30 wt. % of the total weight of the vegan cheese. In one preferred example of this embodiment, the mentioned starch can be selected from one or the combination of the group consisted of: glutinous rice flour, tapioca flour, rice flour, and starch acetate. In one preferred example of this embodiment, the mentioned vegetable oils and fats can be selected from one or the combination of the group consisted of: coconut oil, palm oil, and nut oil.

In one preferred example of this embodiment, the composition of vegan cheese may comprise vegetable protein in an amount of about 0-3 wt. % of the total weight of the vegan cheese. In one preferred example of this embodiment, the mentioned vegetable protein can be selected from one or the combination of the group consisted of: pea protein, soy protein powder, peanut protein powder, sesame protein powder, and walnut protein powder.

In one preferred example of this embodiment, the composition of vegan cheese may comprise thickener in an amount of about 0-1.0 wt. % of the total weight of the vegan cheese. In one preferred example of this embodiment, the mentioned thickener can be selected from one or the combination of the group consisted of: Xanthan gum, and carrageenan.

In one preferred example of this embodiment, the composition of vegan cheese may comprise flavoring agent in an amount of about 2.0-5.0 wt. % of the total weight of the vegan cheese. In one preferred example of this embodiment, the mentioned flavoring agent can be selected from one or the combination of the group consisted of: salt, sugar, aspartame, acesulfame, and sucralose.

In one preferred example of this embodiment, the composition of vegan cheese may comprise emulsifying salt in an amount of about 0.5-1.0 wt. % of the total weight of the vegan cheese. In one preferred example of this embodiment, the mentioned emulsifying salt can be selected from one or the combination of the group consisted of: calcium lactate.

In one preferred example of this embodiment, the composition of vegan cheese may comprise acidulant in an amount of about 0.1-0.9 wt. % of the total weight of the vegan cheese. In one preferred example of this embodiment, the mentioned acidulant can be selected from one or the combination of the group consisted of: citric acid.

In one preferred example of this embodiment, the composition of vegan cheese may comprise functional additive in an amount of about 1.0-5.0 wt. % of the total weight of the vegan cheese. In one preferred example of this embodiment, the mentioned functional additive can be selected from one or the combination of the group consisted of: nutritional yeast, flavor, n-carotene, and water soluble dietary fiber.

Another preferred embodiment according to this specification discloses a method of preparing vegan cheese. The mentioned method of preparing vegan cheese comprises the steps of preparing a starch aqueous solution, adding melted vegetable oils and fats into the starch aqueous solution in small portions, and uniformly stirring to emulsify the starch aqueous solution containing the vegetable oils and fats.

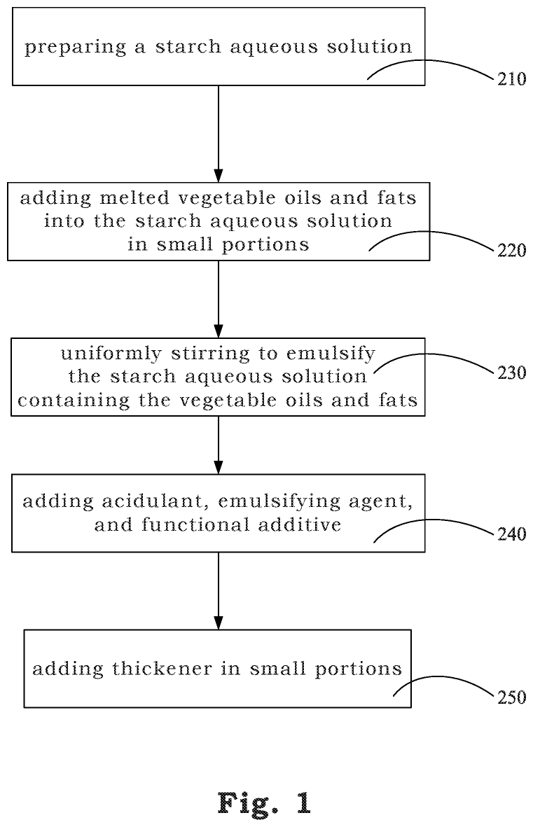

FIG. 1 shows a flowchart of a method of preparing vegan cheese of this embodiment. First, a starch aqueous solution is prepared, as shown in the step 210. The mentioned starch aqueous solution comprises solid dry material, and water. In one preferred example of this embodiment, the mentioned step 210 can be that the solid dry material can be pulverized, sieved with a sieve of about 30 meshes firstly, and the sieved solid dry material is mixed with water to prepare the starch aqueous solution.

In one preferred example of this embodiment, the solid dry material and water are mixed with a rotation speed of about 800-3000 rpm. In one preferred example of this embodiment, the solid dry material and water are mixed with a rotation speed of about 1000 rpm.

In one preferred example of this embodiment, the solid dry material comprises starch. In another preferred example of this embodiment, the solid dry material comprises starch, and vegetable protein. In another preferred example of this embodiment, the solid dry material comprises starch, vegetable protein, and flavoring agent.

In one preferred example of this embodiment, the water in the step 210 is about 40-55 wt. % of the total weight of the vegan cheese. In one preferred example of this embodiment, the mentioned starch can be selected from one or the combination of the group consisted of: glutinous rice flour, tapioca flour, rice flour, and starch acetate.

In one preferred example of this embodiment, the vegetable protein in the step 210 is about 0-3 wt. % of the total weight of the vegan cheese. In one preferred example of this embodiment, the mentioned vegetable protein can be selected from one or the combination of the group consisted of: pea protein, soy protein powder, peanut protein powder, sesame protein powder, and walnut protein powder.

In one preferred example of this embodiment, the flavoring agent in the step 210 is about 2-5 wt. % of the total weight of the vegan cheese. In one preferred example of this embodiment, the mentioned flavoring agent can be selected from one or the combination of the group consisted of: salt, sugar, aspartame, acesulfame, and sucralose.

Next, as shown in the step 220, the vegetable oils and fats are added into the starch aqueous solution in the step 210 in small portions. In one preferred example of this embodiment, if the vegetable oils and fats are in a solid state, the vegetable oils and fats can be melted at a temperature which does not damage the vegetable oils and fats before added into the starch aqueous solution in small portions. In one preferred example of this embodiment, the mentioned temperature is about 40-50° C. In one preferred example of this embodiment, when the vegetable oils and fats is added to the starch aqueous solution in small portions in batches, the starch aqueous solution and the vegetable oils and fats may be mixed at a rotation speed of about 1000 to 4000 rpm. In one preferred example of this embodiment, when the vegetable oils and fats is added to the starch aqueous solution in small portions in batches, the starch aqueous solution and the vegetable oils and fats may be mixed at a rotation speed of about 2000 rpm.

In one preferred example of this embodiment, the mentioned vegetable oils and fats can be selected from one or the combination of the group consisted of: coconut oil, palm oil, and nut oil. In one preferred example of this embodiment, the vegetable oils and fats is about 20-25 wt. % of the total weight of the vegan cheese.

Subsequently, uniformly stirring is performed to emulsify the starch aqueous solution containing the vegetable oils and fats, as shown in the step 230. In one preferred example of this embodiment, in the step 230, the aqueous solution of the vegetable oils and fats and starch may be stirred at a rotation speed of about 1000-4000 rpm, so that the aqueous solution of the vegetable oils and fats and starch becomes thick and viscous. In one preferred example of this embodiment, the aqueous solution of the vegetable oils and fats and starch may be stirred at a rotation speed of about 2000 rpm. In one preferred example of this embodiment, the stirring time of the step 230 can be about 5-20 minutes. In one preferred example of this embodiment, the stirring time of the step 230 can be about 10 minutes. In one preferred example of this embodiment, the step 230 can be performed at about 50-90° C. In one preferred example of this embodiment, the step 230 can be performed at about 60-70° C.

In one preferred example of this embodiment, the method of preparing vegan cheese can further comprise a step of adding acidulant, emulsifying agent, and functional additive, as shown in the step 240. The additive(s) can be added into the emulsified aqueous solution of the starch and the vegetable oils and fats in the step 240 depending on the requirements of the vegan cheese product, wherein the additive(s) is selected from one or the combination of the group consisted of: acidulant, emulsifying salt, and functional additive. In one preferred example of this embodiment, the emulsified aqueous solution of the starch and the vegetable oils and fats may be stirred at a rotation speed of about 1000-4000 rpm in the step 240. In one preferred example of this embodiment, the emulsified aqueous solution of the starch and the vegetable oils and fats may be stirred at a rotation speed of about 2000 rpm in the step 240. In one preferred example of this embodiment, the step 240 can be performed at about 50-90° C. In one preferred example of this embodiment, the step 240 can be performed at about 60-70° C.

In one preferred example of this embodiment, the mentioned acidulant can be selected from one or the combination of the group consisted of: citric acid. In one preferred example of this embodiment, the mentioned acidulant can be about 0.1-0.9 wt. % of the total weight of the vegan cheese.

In one preferred example of this embodiment, the mentioned emulsifying salt can be selected from one or the combination of the group consisted of: calcium lactate. In one preferred example of this embodiment, the mentioned emulsifying salt can be about 0.5-1.0 wt. % of the total weight of the vegan cheese.

In one preferred example of this embodiment, the mentioned functional additive can be selected from one or the combination of the group consisted of: nutritional yeast, flavor, β-carotene, and water soluble dietary fiber. In one preferred example of this embodiment, the mentioned functional additive can be about 1.0-5.0 wt. % of the total weight of the vegan cheese.

In one preferred example of this embodiment, the mentioned method of preparing vegan cheese can further comprise the step of adding thickener in portions. The thickener can be added into the emulsified aqueous solution of the starch and the vegetable oils and fats depending on the requirements of the vegan cheese product, as shown in the step 250. In one preferred example of this embodiment, the emulsified aqueous solution of the starch and the vegetable oils and fats may be stirred at a rotation speed of about 1000-4000 rpm in the step 250. In one preferred example of this embodiment, the emulsified aqueous solution of the starch and the vegetable oils and fats may be stirred at a rotation speed of about 2000 rpm in the step 250. In one preferred example of this embodiment, the step 250 can be performed at about 50-90° C. In one preferred example of this embodiment, the step 250 can be performed at about 60-70° C.

In one preferred example of this embodiment, the mentioned thickener can be selected from one or the combination of the group consisted of: Xanthan gum, and carrageenan. In one preferred example of this embodiment, the mentioned thickener can be about 0-1 wt. % of the total weight of the vegan cheese.

In order to illustrate this specification, the preferred examples of the composition of vegan cheese and method of preparing the same according to the invention are described in the following. However, the scope of the invention should be based on the claims, but is not restricted by the following examples.

Apparatus:

Desktop pulverizer: Mill Powder Tech Solution Co., Ltd., Taiwan

High shear mixer: L5M-A, Silverson Machines Ltd, Chesham, U.K.

Heating mantle: Dogger Instruments Co., Ltd., Taiwan

### Example 1: Method of Preparing Vegan Cheese

First, the solid dry materials are separately treated with a desktop pulverizer, sieved with a 30 meshes screen, and then used. The mentioned solid dry materials can be selected from one or the combination of the group consisted of: starch, vegetable protein, and flavoring agent.

And, vegetable oils and fats can be prepared. If the vegetable oils and fats are in a solid state because of a low room temperature, the vegetable oils and fats can be heated at a temperature not deteriorating the vegetable oils and fats, for example about 40-50° C., until the vegetable oils and fats is completely melted into a liquid state.

The above-mentioned solid dry materials and water are uniformly mixed with a shear mixer at a rotation speed of 1000 rpm for preparing a starch aqueous solution.

The mentioned vegetable oils and fats are added into the starch aqueous solution in small portions, and stirred to confirm that the starch aqueous solution containing the vegetable oils and fats becomes a uniformly emulsified aqueous solution of the starch and the vegetable oils and fats. Before adding the vegetable oils and fats, it is necessary to confirm that the vegetable oils and fats are completely liquid. The starch aqueous solution containing the vegetable oils and fats can be heated to about 65° C. to carry out a condition reaction, and the stirring speed of the shear mixer is maintained for about 10 minutes to make the starch aqueous solution containing the vegetable oils and fats become thick.

In this example, in order to briefly illustrate the general production process of the vegan cheese of this present specification, the stirring speed of the shear mixer is fixed from the step of adding the vegetable oils and fats into the starch aqueous solution to the end of the process. The number of stirring speed (rpm) and the weight percentage (wt. %) of each component in each of the formulations in this example are shown in Table 1 below.

Next, acidulant, emulsifying agent, functional additive or the like are sequentially added into the emulsified aqueous solution of the starch and the vegetable oils and fats, and the temperature is maintained at about 65° C.

Then, thickener is added in small portions into the mentioned emulsified aqueous solution of the starch and the vegetable oils and fats, and the temperature is maintained at about 65° C. After uniformly stirring, the mentioned emulsified aqueous solution of the starch and the vegetable oils and fats becomes viscous.

Subsequently, the mentioned emulsified aqueous solution of the starch and the vegetable oils and fats is continuously stirred, and the temperature of the heating mantle is slowly raised to 80-85° C. to complete the process.

According to this example, because the stirring intensity in the process is sufficient to allow the aqueous solution of the starch and the vegetable oils and fats to be emulsified as a whole, it is not necessary to use any emulsifier (such as lecithin) in the above process. In order to maintain the emulsified state of the vegan cheese product, a thickener (such as Xanthan gum, carrageenan) may be added to the above process to assist the emulsified state stability of the vegan cheese product.

TABLE 1
Vegan cheese formulations

| | | Formulation | | | | | | |
|---|---|---|---|---|---|---|---|---|
| Component | | 1 | 2 | 3 | 4 | 5 | 6 | 7 |
| water | water | 47.34 | 47.34 | 47.16 | 43.47 | 53.67 | 47 | 47 |
| starch | starch | 10.21 | 8.18 | 9.45 | 12.5 | 8 | 8.65 | — |
| | tapioca flour | 7.4 | 7.65 | 6.04 | 11.1 | 2 | 9 | 15 |
| | glutinous rice | 3.84 | 5.62 | 6.54 | — | — | 3 | 10 |
| | flour | | | | | | | |
| | rice flour | — | — | — | — | 5 | — | — |
| vegetable | coconut oil | 12.31 | 12.12 | 11.95 | 13 | — | 12.5 | 13 |
| oils and | palm oil | 9.47 | 9.32 | 6.19 | 10 | 23 | 9 | 10 |
| fats | nut oil | — | — | 3 | — | — | — | — |
| vegetable | pea protein | 2.8 | 2.8 | 2.76 | 3 | 2.75 | 3 | — |
| protein | | | | | | | | |
| thickener | Xanthan gum | 0.2 | 0.2 | 0.19 | 0.2 | 0.3 | 0.2 | — |
| | carrageenan | 0.79 | 0.79 | 0.78 | 0.5 | — | 0.5 | — |
| emulsifying | calcium | 0.77 | 0.77 | 0.76 | 0.83 | 0.83 | 0.9 | 0.8 |
| salt | lactate | | | | | | | |
| acidulant | citric acid | 0.14 | 0.14 | 0.14 | 0.15 | 0.14 | 0.2 | 0.2 |
| flavoring | salt | 1.73 | 2.07 | 2.04 | 2.25 | 1.31 | 2 | 2 |
| agent | sugar | 1 | 1 | 1 | 1 | 1 | 1 | 1 |
| functional | nutritional | 1 | 1 | 1 | 1 | 1 | 1 | 1 |
| additive | flavor | 1 | 1 | 1 | 1 | 1 | 1 | — |
| | β-carotene | — | — | — | — | — | 0.05 | — |
| | water soluble | — | — | — | — | — | 1 | — |
| | dietary fiber | | | | | | | |
| Total | Sum | 100 | 100 | 100 | 100 | 100 | 100 | 100 |
| stirring | rpm | 2000 | 2500 | 2500 | 3000 | 2000 | 2500 | 3000 |
| speed | | | | | | | | |

### Example 2: Stability Evaluation

In view of thermodynamics, emulsified product is unstable. When the storage time is long enough, the original mutually incompatible oil-water phase in an emulsified product will gradually separate. Therefore, it is necessary to confirm the emulsification stability of the vegan cheese at the storage time. In order to test the emulsification stability, the product temperature or vibration energy is increased for the accelerated aging test to confirm whether any physical or chemical changes are generated on the vegan cheese during the mentioned test. In this example, the vegan cheese samples of the mentioned Formulation 2 are separately stored at 30° C., 40° C., 50° C., and 60° C. for one month.

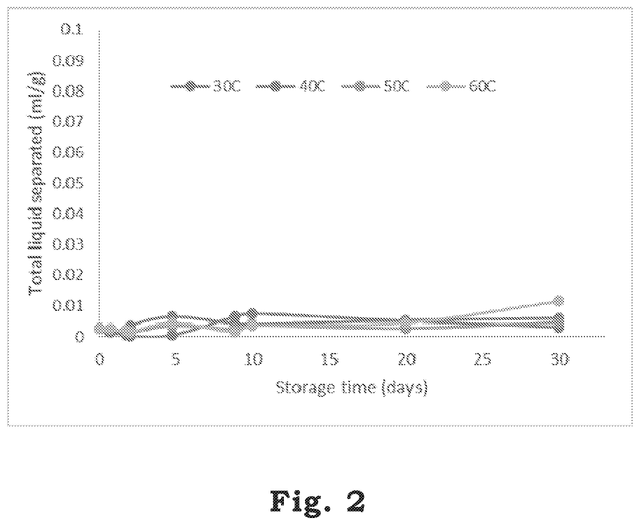

It can be found from the experimental results that the emulsion stability of the mentioned Formulation 2 is very good. The separation amounts of the mentioned vegan cheese samples are all less than 0.01 mL/g, and there is still a considerable gap of the mentioned experimental results with the quality limit of 0.1 mL/g. So that the vegan cheese product of Formulation 2 is very stable. The emulsified stability of the vegan cheese samples of the Formulation 2 separately stored at 30° C., 40° C., 50° C., and 60° C. for one month is shown in FIG. 2.

### Example 3: Storage Period Evaluation

First, a batch of the vegan cheese sample of the above-mentioned Formulation 2 is prepared and respectively stored in a refrigerated and frozen environment. The mentioned vegan cheese samples are individually taken out the following experiments at each time point: based on the Inspection Method for Food Microorganisms—Examination of the number of bacteria of No. 1011902832, the Inspection Method for Food Microorganisms—Examination of Escherichia coli of No. 1011902820, and the Inspection Method for Food Microorganisms—Examination of Escherichia coli of No. 0900025538 to prepare the test liquid samples, wherein the mentioned inspection methods are taught by the Department of Health of the Executive Yuan of the Republic of China, the Department of Health. The mentioned test liquid samples are sequentially used on 3M™ rapid test strip for the analysis of bacterial count, Escherichia coli, and coliform group.

The vegan cheese samples of Formulation 2 are subjected to microbial storage stability test. After respectively stored in a refrigerated and frozen environment, the total plate count and Escherichia coli/coliform group of the mentioned vegan cheese samples of Formulation 2 are analyzed, and the experimental results are shown in Table 2. According to the experimental results of this example, after stored in a refrigerated and frozen environment for three months, the total plate count of the vegan cheese samples of Formulation 2 are maintained at 10¹-10² CFU/mL, and Escherichia coli/coliform group of the vegan cheese samples of Formulation 2 are not detected.

TABLE 2
Changes of the total plate count and Escherichia coli/
coliform group of the vegan cheese samples

| | refrigerated environment | | frozen environment | |
|---|---|---|---|---|
| Stored | | Escherichia | | Escherichia |
| environment | total | coli/ | total | coli/ |
| Stored | plate | coliform | plate | coliform |
| time | count | group | count | group |
| 0 month | 7.2 × 10¹ | — | 7.2 × 10¹ | — |
| 1 month | 7.8 × 10¹ | — | 7.3 × 10¹ | — |
| 2 months | 8.5 × 10¹ | — | 6.9 × 10¹ | — |
| 3 months | 9.2 × 10¹ | — | 5.6 × 10¹ | — |

Note:
“—” means “Not detected”, and the microbiological detection limit is 10 CFU/g.

In this example, another storage evaluation is performed by a sensory evaluation of hands with the Triangle test. Eight untrained panelists are employed to compare the texture quality (such as elasticity, viscosity, firmness, breakage, and so on) of the mentioned vegan cheese samples after stored in a refrigerated and frozen environment with the initial vegan cheese sample. The intention is to confirm whether the texture quality of the mentioned vegan cheese samples is changed due to storage temperature or with prolonged storage time.

First, a batch of the vegan cheese sample of the above-mentioned Formulation 2 is prepared and respectively stored in a refrigerated and frozen environment. The mentioned vegan cheese samples of Formulation 2 are individually taken out at each time point and compared to the initially prepared vegan cheese sample for sensory texture differences. The results of the above-mentioned comparison are presented in Table 3 below. It can be found from Table 3 that the untrained panelists find that there is no significant texture quality difference between the vegan cheese sample stored in the refrigerated and frozen environment for 3 months and the initial vegan cheese sample.

TABLE 3
Sensory evaluation of hands with Triangle
test results of the vegan cheese sample during storage

| Stored | | |
|---|---|---|
| environment | refrigerated | frozen |
| Stored time | environment | environment |
| 1 month | X | X |
| 2 months | X | X |
| 3 months | X | X |

Note 1:
The control group is initially prepared vegan cheese sample (of Formulation 2).
Note 2:
The experimental group compared with the control group, when p < 0.05 means a significant difference, indicating the distinguishable difference.
Note 3:
“X” means not able to distinguish the difference; “O” means able to distinguish the difference.

### Example 4: Sensory Quality Analysis of Vegan Cheese

The texture difference of the vegan cheese samples in Formulation 1, Formulation 2, and Formulation 3 in Example 1 are compared by the references of hand evaluated terms for cheese (Journal of Texture Studies, 1999, 30, 451-476). The evaluated project includes the elasticity, viscosity, firmness, and fracture of the vegan cheese samples. The mentioned evaluation average is performed by 15 untrained panelists, and the quality limit of each inspection target item is 4.0. And, the quality of the texture of the vegan cheese samples of Formulation 1, Formulation 2, Formulation 3, and a commercially available pizza cheese is compared by the Triangle test of the sensory evaluation.

First, the vegan cheese samples of Formulation 1, Formulation 2, and Formulation 3 are respectively placed on white bread. After heating by a commercial oven (HITACHI, MRO-RBK5500T) for 10 minutes in backed mode, hand texture evaluations are performed by 15 untrained panelists. The results of the hand texture evaluation are shown in Table 4 below.

TABLE 4
hand texture evaluation of the vegan
cheese samples

| Formulation | | | |
|---|---|---|---|
| Evaluated term | 1 | 2 | 3 |
| elasticity | 4.2 | 4.1 | 4.3 |
| viscosity | 4.1 | 4.5 | 4.2 |
| firmness | 4.6 | 4.1 | 4.5 |
| fracture | 4.2 | 4.6 | 4.3 |
| total | 4.1 | 4.2 | 4.0 |

Note:
The score sheet is 0-5.

Then, the difference between the vegan cheese samples of Formulations 1, 2, and 3 and the commercially available pizza cheese is individually evaluated by the Triangle test. The results of the mentioned Triangle test are shown in Table 5 below. As shown in the Triangle test results in Table 5, 15 untrained panelists can distinguish the difference between the vegan cheese sample of Formulation 3 and the commercially available pizza cheese. There are 6 untrained panelists can distinguish the difference between the vegan cheese sample of Formulation 1 and the commercially available pizza cheese, and There are 2 untrained panelists can distinguish the difference between the vegan cheese sample of Formulation 2 and the commercially available pizza cheese. Based on the mentioned Triangle test results, there is no significant difference between the vegan cheese sample of Formulation 1 and the commercially available pizza cheese, and there is no significant difference between the vegan cheese sample of Formulation 2 and the commercially available pizza cheese. And, the difference between the sensory quality of the vegan cheese sample of Formulation 2 and the commercially available pizza cheese is less than or equal to 20% (less than 3 of 10 untrained panelists can distinguish the difference).

TABLE 5
Triangle test results of the vegan cheese
samples and the commercially available pizza cheese

| | Correct/number of | |
|---|---|---|
| | untrained panelists | Significance |
| Formulation 1 | 6/15 | p > 0.05 |
| Formulation 2 | 2/15 | p > 0.05 |
| Formulation 3 | 15/15 | p < 0.001 |

Note 1:
The control group is pizza conditioning special cheese from Power Red International Co., Ltd., R.O.C.
Note 2:
The experimental group compared with the control group, p < 0.05 means a significant difference.

In summary, we have reported a composition of vegan cheese and method of preparing the same. The mentioned composition of vegan cheese and method of preparing the same can provide vegan cheese close to real cheese, wherein the mentioned vegan cheese does not use any emulsifier. According to this specification, the mentioned composition of vegan cheese without any emulsifier comprises water, starch, vegetable protein, and vegetable oils and fats. The mentioned composition of vegan cheese without any emulsifier can further comprise the component(s) selected from one or the combination of the group consisted of: thickener, emulsifying agent, acidulant, flavoring agent, and functional additive. Based on this specification, the mentioned method of preparing vegan cheese without any emulsifier can provide the aqueous solution of the starch and the vegetable oils and fats to be emulsified as a whole by the sufficient stirring intensity, and does not need to use any emulsifier. Therefore, the mentioned composition of vegan cheese and method of preparing the same are more in line with health requirements. That is, this specification provides vegan cheese with stable quality, close to real cheese, and in line with health requirements.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. A composition of vegan cheese without any emulsifier, comprising:
water in an amount of 40-55 wt. % of the total weight of the vegan cheese;
vegetable oils and fats in an amount of 20-25 wt. % of the total weight of the vegan cheese, wherein the mentioned vegetable oils and fats is selected from one or the combination of the group consisted of: coconut oil, palm oil, and nut oil; and
starch in an amount of 10-30 wt. % of the total weight of the vegan cheese, wherein the mentioned starch is selected from one or the combination of the group consisted of: glutinous rice flour, tapioca flour, rice flour, and starch acetate.

2. The composition of vegan cheese without any emulsifier according to claim 1 further comprises vegetable protein in an amount of 0-3 wt. % of the total weight of the vegan cheese, wherein the mentioned vegetable protein is selected from one or the combination of the group consisted of: pea protein, soy protein powder, peanut protein powder, sesame protein powder, and walnut protein powder.

3. The composition of vegan cheese without any emulsifier according to claim 1 further comprises thickener in an amount of 0-1 wt. % of the total weight of the vegan cheese, wherein the mentioned thickener is selected from one or the combination of the group consisted of: Xanthan gum, and carrageenan.

4. The composition of vegan cheese without any emulsifier according to claim 1 further comprises emulsifying salt in an amount of 0.5-1.0 wt. % of the total weight of the vegan cheese, wherein the mentioned emulsifying salt is calcium lactate.

5. The composition of vegan cheese without any emulsifier according to claim 1 further comprises acidulant in an amount of 0.1-0.9 wt. % of the total weight of the vegan cheese, wherein the mentioned acidulant is citric acid.

6. The composition of vegan cheese without any emulsifier according to claim 1 further comprises functional additive in an amount of 1.0-5.0 wt. % of the total weight of the vegan cheese, wherein the mentioned functional additive is selected from one or the combination of the group consisted of: nutritional yeast, flavor, n-carotene, and water soluble dietary fiber.

7. The composition of vegan cheese without any emulsifier according to claim 1 further comprises flavoring agent in an amount of 2.0-5.0 wt. % of the total weight of the vegan cheese, wherein the mentioned flavoring agent is selected from one or the combination of the group consisted of: salt, sugar, aspartame, acesulfame, and sucralose.

8. A method of preparing vegan cheese without any emulsifier, comprising:
preparing a starch aqueous solution, wherein the starch aqueous solution comprises solid dry material, and water, wherein the mentioned solid dry material comprises starch, and vegetable protein;
adding melted vegetable oils and fats into the starch aqueous solution in portions; and
uniformly stirring to emulsify the mentioned starch aqueous solution containing the mentioned vegetable oils and fats to provide a emulsified aqueous solution of the starch and the vegetable oils and fats, wherein the mentioned starch aqueous solution containing the mentioned vegetable oils and fats is stirred at a rotation speed of 1000-4000 rpm, and 50-90° C.

9. The method of preparing vegan cheese without any emulsifier according to claim 8 further comprises a step of adding acidulant, emulsifying agent, and functional additive into the emulsified aqueous solution of the starch and the vegetable oils and fats, wherein the mentioned step of adding acidulant, emulsifying agent, and functional additive into the emulsified aqueous solution of the starch and the vegetable oils and fats is stirred at a rotation speed of 1000-4000 rpm, and 50-90° C.

10. The method of preparing vegan cheese without any emulsifier according to claim 8 further comprises a step of adding thickener into the emulsified aqueous solution of the starch and the vegetable oils and fats in portions, wherein the step of adding thickener into the emulsified aqueous solution of the starch and the vegetable oils and fats is stirred at a rotation speed of 1000-4000 rpm, and 50-90° C.
